(19) United States
(12) Patent Application Publication
(10) Pub. No.: US 2011/0119269 A1
(43) Pub. Date: May 19, 2011

(54) Concept Discovery in Search Logs

(76) Inventors: Rakesh Agrawal, San Jose, CA (US); Sreenivas Gollapudi, Cupertino, CA (US); Nina Mishra, Newark, CA (US)

(21) Appl. No.: 12/620,600

(22) Filed: Nov. 18, 2009

(51) Int. Cl. G06F 17/30

(52) U.S. Cl. 707/737; 707/769; 707/E17.014; 707/E17.046

(57) ABSTRACT

Described is a search (e.g., web search) technology in which concepts are returned in response to a query in addition to (or instead of) search results in the form of traditional links. Each concept generally corresponds to a set of links to content that are more directed towards a possible user intention, or information need, with respect to that query. If a user selects a concept, that concept's links are exposed to facilitate selection of a document the user finds relevant. In this manner, much more than the top ten ranked links may be provided for a query, each set of other links arranged by the concepts. Also described is processing a query log or other data store to optionally find related queries and find the concepts, e.g., by clustering a relationship graph built from the query log to find dense subgraphs representative of the concepts.

### BACKGROUND

Contemporary search engines for user queries perform searches that are generally based upon keyword searching. Depending on the keywords within a query, search engines find matching documents and rank them based on likely relevance. Links to some number of these documents are then returned as search results, e.g., the top ten links.

Even though all ten links may be relevant to a query, a user often does not find a desired result among those first ten links. Sometimes this is because users seek to gain general information about an idea that perhaps can be expressed in multiple ways, or because the idea has multiple dimensions. For example, consider various users posing the same query “economic crisis” in the 2008 timeframe. Each user may be interested in a different component of the 2008 crisis, such as the housing meltdown, bank bailouts, mortgage-backed securities, stock market, credit defaults, auto companies, and so forth. In cases such as this in which there are so many possible user intentions, there is no set of ten links that can satisfactorily answer the query for all users. Moreover, the words “economic crisis” may not even appear within a document that a user may consider highly relevant and want to see.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which concepts are returned in response to a query in addition to (or instead of) search results in the form of traditional links. Each concept corresponds to a set of links to content that in general are more directed towards a possible user intention for that query. If a user selects a concept, that concept's links are exposed to facilitate selection of a document the user finds relevant.

In one aspect, the concepts are maintained in a concept data store that is built offline. To this end, a data store such as a query log may be optionally processed so as to find related queries, and another data source is processed into a relationship graph, e.g., an expression-URL graph. Clustering is performed on the relationship graph, such that each cluster corresponds to a concept and identifies a collection of queries and a set of URLs. Clustering may operate by finding dense subgraphs in the relationship graph, e.g., subgraphs that meet an internal density condition and (optionally) an external sparsity condition.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a representation showing an example browser window that shows how concepts may be presented to a user in response to a query.

FIG. 2 is a block diagram showing example components for returning concepts in response to a query.

FIG. 3 is a representation of a relationship graph (e.g., query-click graph) that is processed to determine clusters of information needs corresponding to concepts.

FIG. 4 is a flow diagram showing example steps related to returning concepts for queries.

FIG. 5 shows an illustrative example of a computing environment into which various aspects of the present invention may be incorporated.

### DETAILED DESCRIPTION

Various aspects of the technology described herein are generally directed towards a search engine that provides a rich user experience by presenting key concepts related to a search, in addition to (or instead of) conventional search results. To this end, based upon information needs (described below) that are generally sets of queries and URLs that are associated with concepts, when a user query is posed, instead of simply finding the ten most relevant document links based upon keyword searching, some number of most relevant concepts are returned. A user can then select the appropriate concept to find relevant links based on the selected concept.

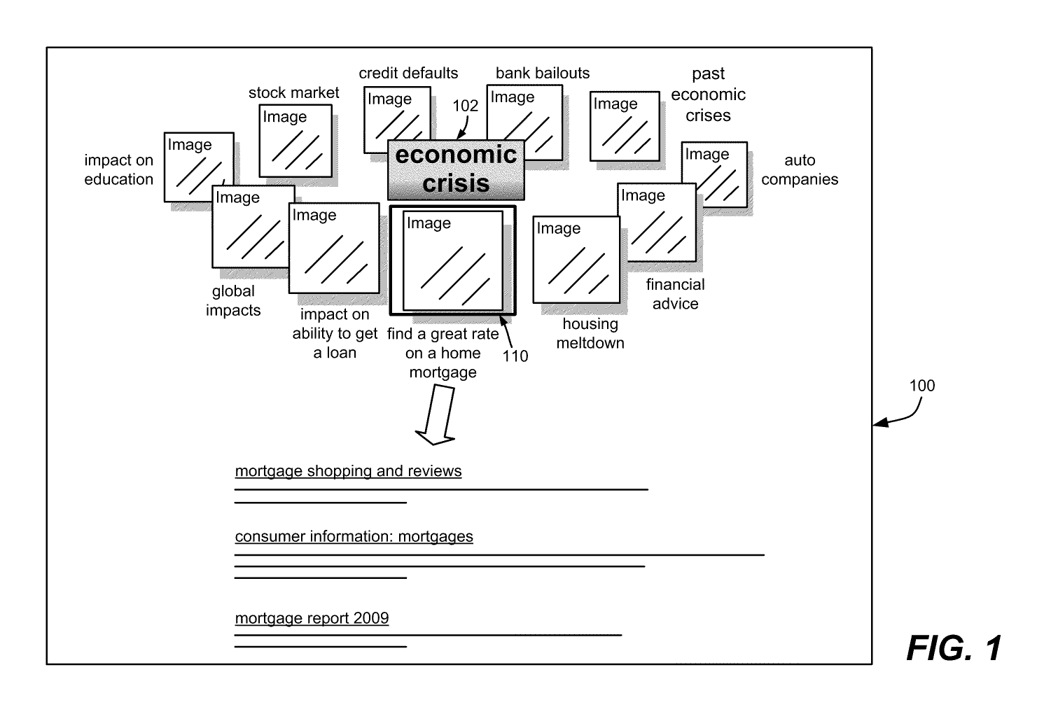

By way of example, a user querying with a simple expression such as “economic crisis” may be interested in any number of economic crisis-related concepts, (whereby such a query likely could not be answered with ten URLs). FIG. 1 shows one example of how such concepts (and some links) may be presented to a user, e.g., in a browser window 100. As can be readily appreciated, FIG. 1 is only one example of many possible ways to display concepts; further, such concepts may occupy an entire browser window or other user interface screen, or may share the window/screen with other content such as with the top ten conventional links, advertisements, related searches and so forth.

In the example of FIG. 1, the user's query “economic crisis” 102 is shown surrounded by relatively more specific text/images that correspond to concepts that the user can click or otherwise select (e.g., rotate, touch and so forth) to see additional content links for that concept. Such additional content links may include predetermined links, and/or the conventional search results that are obtained if the user actually entered the text/terms accompanying each image, e.g., “impact on education” instead of “economic crisis” by itself, or it may be another set of terms, e.g., “impact on ability to get a loan”. Note that one concept (indicated in FIG. 1 by its size and emphasized by the darker surrounding box 110), such as the concept that other users select most often, may be “in focus” or the like and have some accompanying links automatically displayed for that concept. Further, note that one or more of the provided concepts may be commercial in nature, e.g., “find a great rate on a home mortgage,” “financial advice” and so forth. Such commercial concepts may be mixed among non-commercial concepts, or may be a separate set of concepts also returned to the user.

It should be understood that any of the examples herein are non-limiting examples. For example, while web searching is described herein, other searches such as relational database searches and the like may return concepts to help a user zero in on a desired result. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and search/query processing in general.

In one implementation, related queries are first optionally mined from various data sources. In one embodiment, related expressions may be discovered by a random walk on the query-click graph. In another embodiment, a graph is constructed whereby vertices comprise expressions and an edge connects two expressions if one of the following or some combination of the following are satisfied: (a) some or many users pose both expressions in a time window; (b) some or many URLs have both expressions appear in the title; (c) some or many URLs have both expressions appear in the body; (d) some or many URLs have both expressions are used in the anchor text; and/or (e) some or many advertisers bid on both expressions, and so forth. Edge construction is not limited to these sources, but rather reflects some common data sources.

Once such a graph is constructed, any one of many possible clustering algorithms may be used to find related queries. In one embodiment, connected components may form related queries. In another embodiment, spectral clustering may be used to find related queries. Many other clustering methods (e.g., known in the art) may also be applied.

Information needs are mined from data corresponding to prior user actions and other information, wherein each information need is a tuple of (expression, need) pairs, denoted by (Q, N), in which Q refers to a collection of expressions and N refers to a set of web pages. More particularly, for each information need, mining determines a collection of expressions, denoted by Q, any of which may be posed as a search query to express a certain need; for each information need, the set of web pages, N, that satisfy the need is obtained.

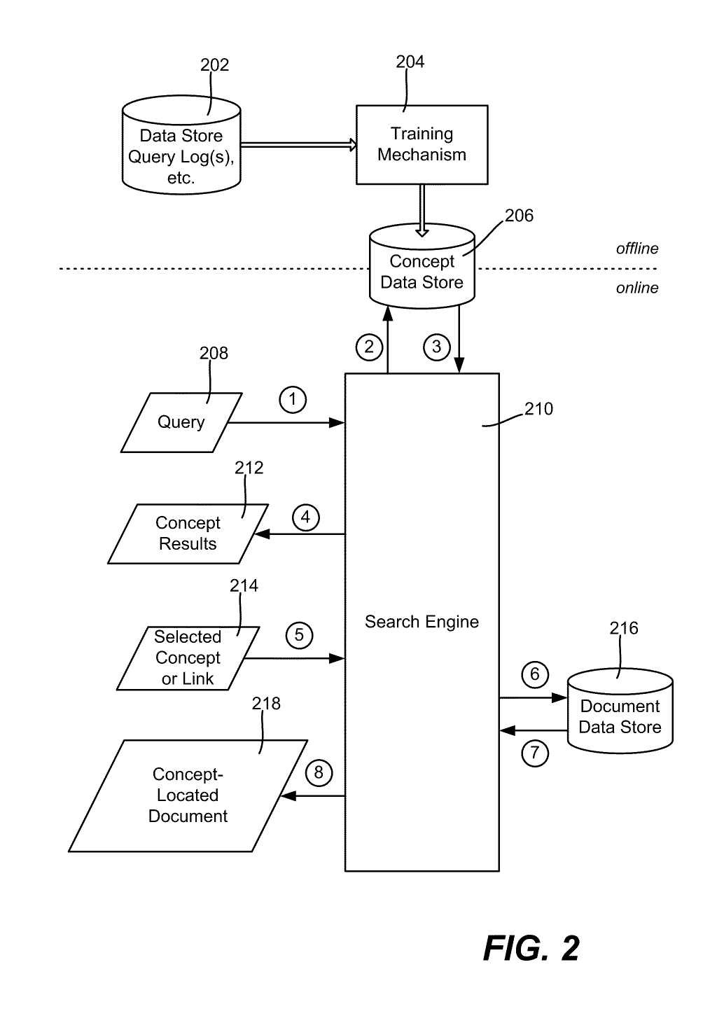

As represented in FIG. 2, one or more search logs 202 or the like are mined and used by a mining mechanism 204 as described below to determine the (Q,N) information needs, which may be maintained in a concept data store 206. As described below, in mining, the search log 202 is processed so as to be represented as at least one bipartite relationship graph, (e.g., Query-Click graph, Anchor-click graph and/or Tag-Click graph), which is then clustered to identify the concepts.

Online query processing is also represented in FIG. 2, in which the circled numerals one (1) through eight (8) generally provide an order of online operations with respect to returning concepts. Given a search query 208, the search engine 210 accesses the concept data store 206 and returns concepts related to the query, if such concepts exist. In one implementation, the concept results 212 are merged with conventional search results, e.g., the top ten links, into a page returned to the user. However, for purposes of this description, such a conventional document search is not described in detail at this time.

If the user receives the concepts and then selects one of the concepts, links to URLs/documents (e.g., the document set N) are provided based on the selected concept 214. In general, these are conventional links ranked by relevance, and may include images, advertisements (e.g., targeted at least in part based upon the concept), and so forth. Note that given a concept, a search may be performed, or the document set N may be known in advance for each concept, and possibly available to the browser via the search results before user selection of a concept. In this example, the search engine 210 then accesses a document data store 216 to provide the document 218 that was chosen from the selected concept.

Turning to aspects related to mining to obtain the concepts, in general each (Q,N) information need is an (expression, need) pair if each query in Q can be used to express a need for each URL in N, and if queries not in Q are not typically used to express a need for URLs in N. Similarly, URLs not in N are not typically clicked in response to queries in Q.

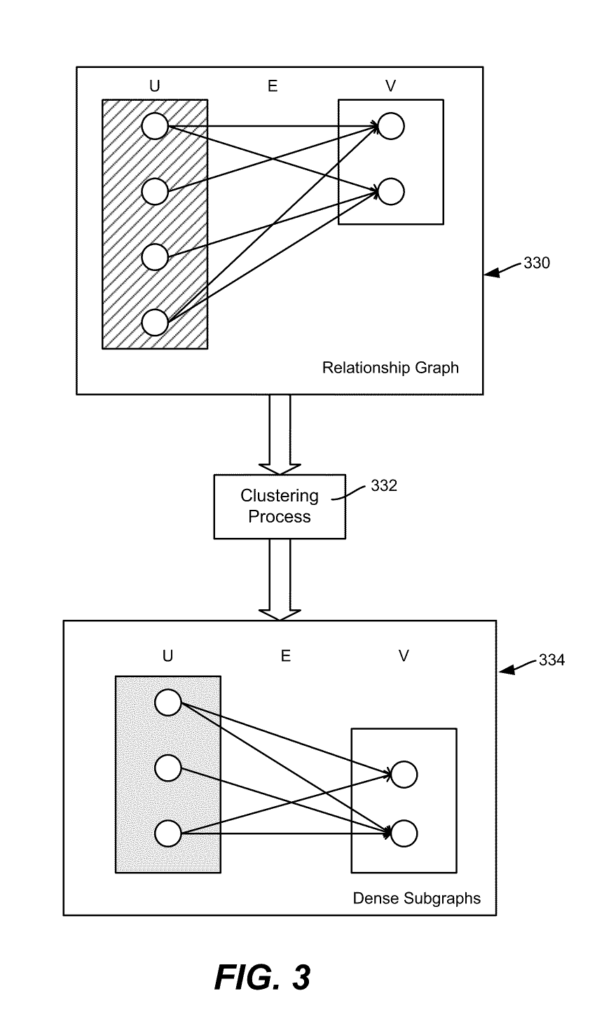

As represented in FIG. 3, the mining mechanism 204 builds a bipartite relationship graph 330, G=(U,V,E), which is then processed by a clustering process 332 to find subgraphs 334 that correspond to the concepts. In one implementation, U represents the vertices comprising queries or expressions, V represents the vertices comprising URLs, and there is an edge E between a query and a URL if a user that submitted a query clicked on the URL that was returned in response to the query, e.g., the graph 330 is a query-click graph. Other types of relationship graphs may use sets of anchor text as the left vertices and URLs on the right, with an edge between each set of anchor text that points a URL. A similar tag-URL graph is another relationship graph that may be constructed and clustered. The relationship graphs may also be combined in a number of ways, e.g., combining the edges from each of the above relationship graphs, or weighting the edges from each.

Note that with respect to interpreting query-click logs and anchor-URL logs, as queries are issued by search users, there can be many ‘noisy’ queries associated with clicks in the query-click logs. Some examples of noisy queries include misspelled queries, pornographic queries, and so forth. Therefore, a set of queries in an expression-need pair (E,N) obtained from the query-click graph are often observed to be small variations of each other. Combining the query click graph with the anchor URL graph can enhance the set of expressions with less noisy expressions. Note that the anchor text used in referring web-pages comprises more carefully edited ‘expressions’ by experts or a select few.

Still other types of relationship graphs are possible; for example, U may again comprise queries, with the vertices V based upon text related to URLs rather than the URLs themselves, such as text found in the title, body, anchor and/or other text of the URL (e.g., the text of the URL string). An edge represents a match between query text and a URL's text.

Moreover, if the optional first step of finding related expressions was performed, then the bipartite graph can be further embellished to include more edges. In one embodiment, if expressions u1 and u2 are known to be related and if expression u1 contains clicks to a set of URLs V′ while expression u2 contains clicks to a set of URLS V″, then the edges in the query click graph can be embellished to include edges from u1 to V′∪V″ and u2 to V′∪V″.

With respect to clustering, given such a relationship graph, the information need can be considered a problem of finding the (expression, need) pairs, which may be solved by finding dense subgraphs. In graph terminology, (Q,N) is an (expression, need) pair if (Q,N) is a dense bipartite subgraph, and optionally each q′ not in Q has few edges into N and each n′ not in N has few edges into Q. Note that there are many ways to find dense subgraphs; one example is described herein, and generally is explained in the context of a query-click graph although any other graphs including those described above may be processed in the same manner.

InformationNeed: Given a bipartite graph G=(U,V,E), find all (Q,N) expression-need pairs, Q⊂U, N⊂V, such that:
(1) Internal Density: (e,n)ε Q for most e ε Q and n ε N.
(2) External Sparsity |Edges(e′, N)|is small for e′ not in E and |Edges(Q,n′)||Q| is small for n′ not in N

The above internal density condition (1) is directed to how dense the edges inside the subgraph are, and may require a complete subgraph, e.g., a subgraph in which all queries have edges to all URLs of the subgraph. This condition may also be such that most vertices U in Q have edges to most vertices V in N, rather than requiring all. One possible definition is |E(N,Q)|>=β|N∥Q|. Another possible relaxation is that for each n in N, |E(n,Q)|>=β|Q| and for each q in Q|E(N,q)|>=β|N|.

Condition (2) relates to external sparsity (alpha, or α), in general so that queries outside of the cluster do not too often result in clicks to URLs that are in the cluster. Although optional, external sparsity is considered for a number of reasons. For one, with only a restriction on density, there is a problem with generating super-polynomially many more (expression, need) pairs than the size of the graph. In practice, it is computationally prohibitive to generate that many information needs. For another, if there are many expressions outside of Q that are used to access most of N, but less than β|N|, then those expressions are to be included in Q, otherwise it is typically better to not even output such an (expression, need) pair.

Turning to properties of expression, need pairs (E,N), note that information needs overlap. For example, single-word queries will almost certainly appear in many information needs. Likewise, popular URLs such as “msn.com” will be satisfied by many information needs. As a result, many well-known clustering algorithms cannot be used for clustering.

In general, when determining information needs, the number of information needs is not specified because the number present in the query, click graph is not known, and a binary search over the number of information needs may be computationally expensive.

With respect to clustering, in one embodiment, information needs can be discovered based upon a champion vertex and its neighbors. In general, a champion vertex is one that “champions” the cluster by having most of its edges into the cluster. Thus a query such as “economic crisis 2008” may be a good champion because it is directed towards one relatively narrow concept; a query such as “jaguar” is not a good champion, as it may refer to a large cat, a car, a football team, an operating system, and so forth. One example algorithm is as follows:
1. For each champion vertex c in U
   a. C={c}
   b. For each vertex v in the neighbors of the neighbors of c
      1. If the neighbors of v intersect the neighbors of c is sufficiently large then
         i. Add v to the cluster C
   c. Output C if it is good cluster

A similar process can be repeated for the vertices in V. The above algorithm is a straightforward modification of an algorithm suggested in the publication entitled “Clustering Social Networks” by Mishra, Schreiber, Stanton and Tarjan, Internet Mathematics, 2009.

Other methods can be used to find co-clusters in a bipartite graph, for example as described by Dhillon, Mallela, Modha, “Information theoretic co-clustering”, In Proceedings of the ACM SIGKDD Conference, 2003,and “On Finding Large Conjunctive Clusters,” Mishra, Ron and Swaminathan, Proceedings of the 16th Annual Conference on Learning Theory (COLT), 2003. If desired, complete bipartite subgraphs may be found using well-known methods.

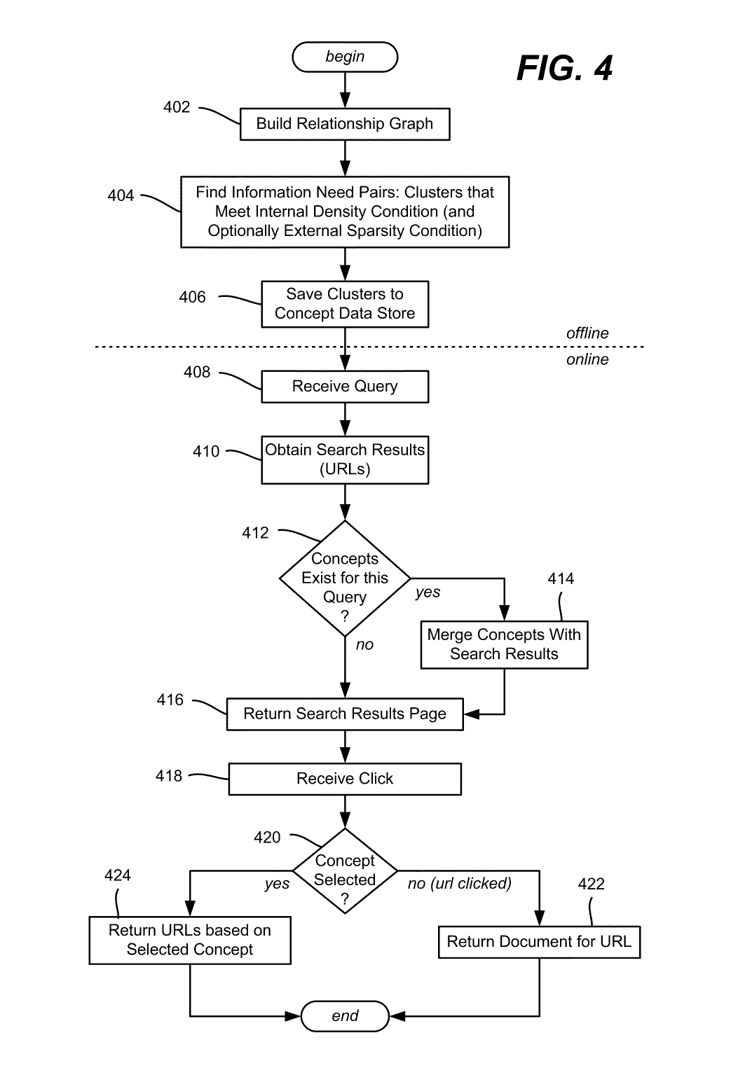

FIG. 4 is a flow diagram summarizing some of the above steps and examples, beginning at step 402 where a query log or other data store is offline processed into a relationship graph. As described above, clustering is performed on the graph at step 404 to find information need pairs, including based on internal density and (optionally) external sparsity conditions. The clusters are saved to a data store as represented by step 406.

Online processing of a query is represented beginning at step 408 where the query is received. In this example, online search results (e.g., document links found via a conventional search) are retrieved at step 410 for merging with any concepts that may exist for this query, as determined via step 412. If concepts exist, they are merged at step 414 with the other search results. Note that an alternative implementation may return only concepts if they exist, or document links if not, rather than a mix of concepts and document links. Step 416 represents returning the search results page.

At this time, the user may click on a concept or a document link as represented by step 418. Note that steps 418 and forward may be handled in the browser code, or in a combination of browser code and server interaction. Further note that other user actions are possible but not considered here, e.g., the user may instead submit a new or modified query, may click on a suggested query in a “related search” or perform another action (e.g., close the browser).

Assuming a concept or a document link is selected, step 420 determines which. If a document link, step 422 operates to return the document corresponding to the URL of the link, e.g., from the server or a local or intermediate cache. If a concept, step 424 exposes the URLs for the selected concept. Note that these URLs may be included in the original search results such that a “concept-aware” browser can provide the links upon concept selection, or further interaction with the server to obtain the links may be performed.

In this manner, concepts based on mined information needs may be included in search results. However, in addition to returning concepts, the identification of information needs may be used for other purposes. For example, information needs may be used to train a document relevance ranking function: if queries q and q′ both belong to the same (expression, need) pair, then the URLs and labels for q can be used to train q′, and vice versa. Alterations or suggestions are other aspects: if a “central” expression in an (expression, need) pair is found, i.e., one that expresses the need most accurately and that yields good results, the central expression may be altered or suggested when a user poses any query in the expression, need pair.

Still another aspect is using the information need as a feature. For example, if a query belongs to Q and a URL belongs to N, where (Q,N) is an (expression, need) pair, then a feature that boosts the score of the query, URL combination may be used.

### EXEMPLARY OPERATING ENVIRONMENT

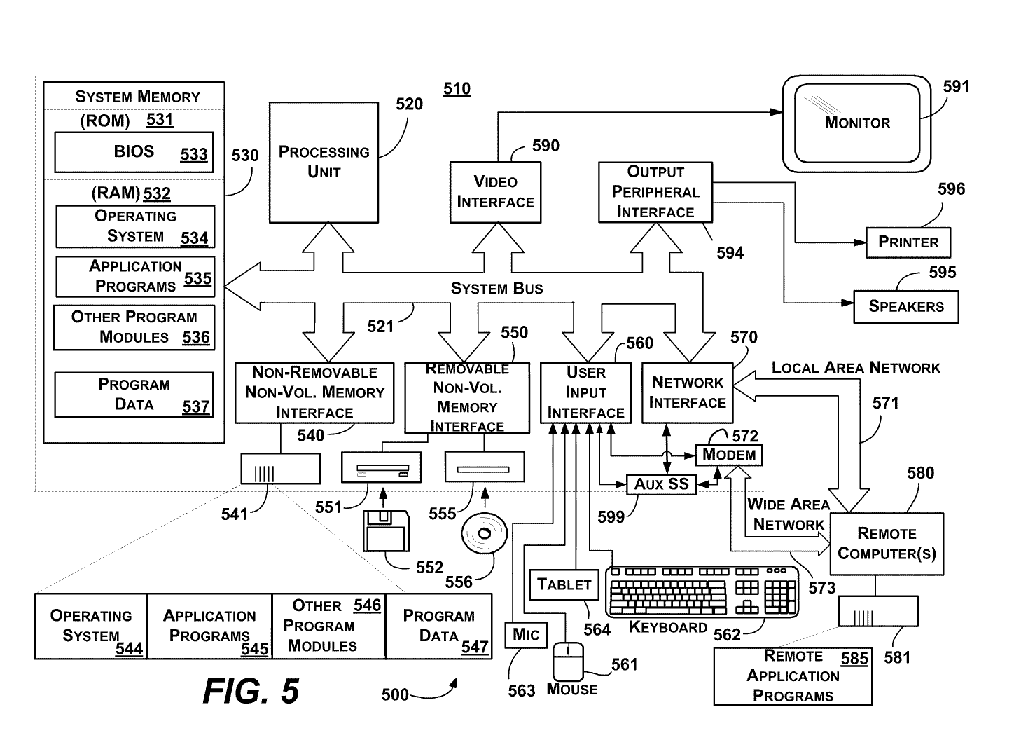

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor, comprising:
processing a query, including returning a set of concepts related to the query, in which each concept corresponds to a set of one or more links to content;
providing a set of links to content for a selected concept; and
returning content for a selected link from the set of links for the selected concept.

2. The method of claim 1 wherein returning the set of concepts comprises providing a web page that when rendered includes a mechanism for selecting the selected concept.

3. The method of claim 1 further comprising, returning at least one link to a document in conjunction with returning the set of concepts.

4. The method of claim 1 further comprising, accessing a concept data store to determine the set of concepts for the query.

5. The method of claim 4 further comprising, processing a data store to build the concept data store.

6. The method of claim 5 wherein processing the data store comprises building a related query graph and building a relationship graph.

7. The method of claim 6 wherein determining related queries comprises finding clusters or connected components in the related query graph, wherein each cluster corresponds to a set of related queries.

8. The method of claim 6 further comprising, augmenting the relationship graph with related queries and determining clusters in the relationship graph, wherein each cluster corresponds to a concept and identifies a collection of queries and a set of URLs.

9. The method of claim 6 wherein determining the clusters comprises finding dense subgraphs in the relationship graph.

10. In a computing environment, a system comprising:
a concept data store containing information needs corresponding to concepts, each information need comprising a query collection, URL set tuple;
a search engine that accesses the concept data store to determine whether a query has associated concepts, and if so, to return the concepts associated with that query in response to the query.

11. The system of claim 10 wherein the search engine further returns at least one document link in conjunction with the concepts.

12. The system of claim 10 wherein the links for each concept are accessible upon selection of a concept.

13. The system of claim 10 further comprising a mining mechanism that builds the concept data store based upon data in at least one other data store.

14. The system of claim 13 wherein the mining mechanism builds the concept data store by processing a data store into a related query graph and an expression URL relationship graph, and by clustering related queries to augment the expression URL graph and clustering the relationship graph into the information needs.

15. The system of claim 14 wherein the related expression graph comprises queries that were posed by a same user in a time window, or keywords bid by a same advertiser, or expressions that appear in the anchor, title, body, or other location of a document, or any combination of queries that were posed by a same user in a time window, or keywords bid by a same advertiser, or expressions that appear in the anchor, title, body, or other location of a document.

16. The system of claim 14 wherein the relationship graph comprises a query-click graph in which one set of vertices represents queries, another set of vertices represents URLs, and for each query vertex, an edge exists from that query vertex to a URL vertex if that URL was clicked after being returned in response to that query.

17. The system of claim 14 wherein the relationship graph is combined with an anchor-URL graph or a tag-URL graph.

18. One or more computer-readable media having computer-executable instructions, which when executed perform steps, comprising, building a relationship graph, in which a first set of vertices represents a search query and a second set of vertices represents information that is capable of having a relationship with each search query based upon user actions, and clustering the relationship graph into information needs, each information need comprising a query collection, URL set tuple.

19. The one or more computer-readable media of claim 19 having further computer-executable instructions, comprising, finding related queries, and wherein building the relationship graph comprises utilizing the related queries.

20. The one or more computer-readable media of claim 19 wherein clustering the relationship graph comprises finding subgraphs in the relationship graph that meet an internal density condition or an external sparsity condition, or both an internal density condition and an external sparsity condition.
